(19) United States
(12) Patent Application Publication
(10) Pub. No.: US 2002/0174021 A1
(43) Pub. Date: Nov. 21, 2002

(54) Optimized shopping list process

(75) Inventors: Heng Chu, Raleigh, NC (US); David B. Lection, Raleigh, NC (US); Eric L. Masselle, Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY (US)

(21) Appl. No.: 09/855,827

(22) Filed: May 15, 2001

(51) Int. Cl. G06F 17/60

(52) U.S. Cl. 705/26

(57) ABSTRACT

Methods, systems, computer program products, and methods of doing business by optimizing a user's shopping and product acquisition experience. A user selects products to be purchased, and an optimized shopping path is automatically computed based upon one or more factors such as product price, merchant location, user preference for particular merchants, and whether a merchant has particular products in inventory. As the user completes acquisition of selected products, the shopping list is preferably revised dynamically. If a product is not in inventory as expected, the shopping path is revised dynamically.

### BACKGROUND OF THE INVENTION

1. Field of the Invention

The present invention relates to a computer system, and deals more particularly with methods, systems, computer program products, and methods of doing business by optimizing a user's shopping and product acquisition experience.

2. Description of the Related Art

Most all humans will, from time to time, conduct a process of developing a shopping list of products to be purchased from merchants in a particular area. Typically, creating the shopping list is a manual process whereby the list is made on a piece of paper and, once the list is completed, the human sets out to fulfill the list by acquiring the listed products. Even the most homogeneous of lists (such as lists for buying groceries, lists for buying household products, lists for buying clothing, and so forth) can often result in buying products from multiple merchants because of differences such as which items are on sale, which items are in inventory, the location of the merchant, etc.

Given today's hectic lifestyle and the demands it places upon people's time, it can be quite bothersome and frustrating for a shopper to have to go from store to store, searching for the items on his or her shopping list. Furthermore, attempting to manually create a shopping list to optimize the shopping experience—for example, to minimize the travel distance or to get the best price on individual items on the list—can be very difficult as well as time-consuming and tedious.

Accordingly, what is needed is a technique that avoids the limitations of the prior art.

### SUMMARY OF THE INVENTION

An object of the present invention is to provide an automated technique for optimizing a user's shopping experience.

Another object of the present invention is to provide a technique for automatically creating a shopping route or path for a user, based upon the items on the user's shopping list.

A further object of the present invention is to provide a technique for automatically creating a shopping route for a user based upon one or more factors such as merchant location, user preferences for particular merchants, and so forth.

Yet another object of the present invention is to automatically and dynamically revise a user's shopping list as the user shops and completes a purchase for particular items on the shopping list.

Still another object of the present invention is to automatically and dynamically revise the shopping path if items are not in inventory as expected.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for optimizing a shopping list process. In preferred embodiments, this technique comprises: obtaining a shopping list comprising one or more items; obtaining one or more factors which a user wishes to use in optimizing a shopping path for the items on the shopping list; determining one or more merchants and locations thereof where the items may be purchased; and computing the shopping path to visit selected ones of the merchants, wherein the merchants are selected according to the one or more obtained factors.

One of the obtained factors may be to optimize a path length for the shopping path, to optimize a purchase cost for the items on the shopping list, or to optimize a number of merchants on the shopping path.

The technique may further comprise: traveling to each successive merchant on the computed shopping path; purchasing zero or more items from the shopping list at each merchant; and remembering which items have been purchased. In this case, the technique may also further comprise creating a revised shopping list which excludes the remembered items; and determining whether items expected at a particular one of the merchants were available for purchase, and if not, recomputing the shopping path after adding the items which were unavailable to the revised shopping list.

The shopping path may begin from an identified starting location and terminate at an identified ending location, which may be identical to the starting location. One or more traveling salesman algorithm implementations may be used when computing the optimized shopping path. The merchants may be dynamically contacted to determine availability of the items on the shopping list. The technique may further comprise computing a summary after visiting the selected merchants, wherein the summary comprises information pertaining to one or more of: which merchants were visited; the remembered items which were purchased; a cost of the remembered items which were purchased; a count of merchants visited; a cost savings of the remembered items which were purchased.

The present invention may also be used advantageously in methods of doing business, for example by providing optimized shopping path locator devices which use the techniques disclosed herein or by providing subscription services with which shoppers may optimize their shopping lists using the techniques of the present invention.

The present invention will now be described with reference to the following drawings, in which like reference numbers denote the same element throughout.

### BRIEF DESCRIPTION OF THE DRAWINGS

FIG. 1 is a block diagram of a computer hardware environment with which the present invention may be practiced;

FIG. 2 illustrates a networked computing environment in which the present invention may be practiced;

FIG. 3 illustrates two alternative approaches for determining a shopping area;

FIG. 4 provides a flowchart depicting logic with which preferred embodiments of the present invention may be implemented; and

FIGS. 5A and 5B illustrate a sample user interface display that may be used to obtain user customization information and to convey shopping information to a user of the present invention, respectively.

### DESCRIPTION OF PREFERRED EMBODIMENTS

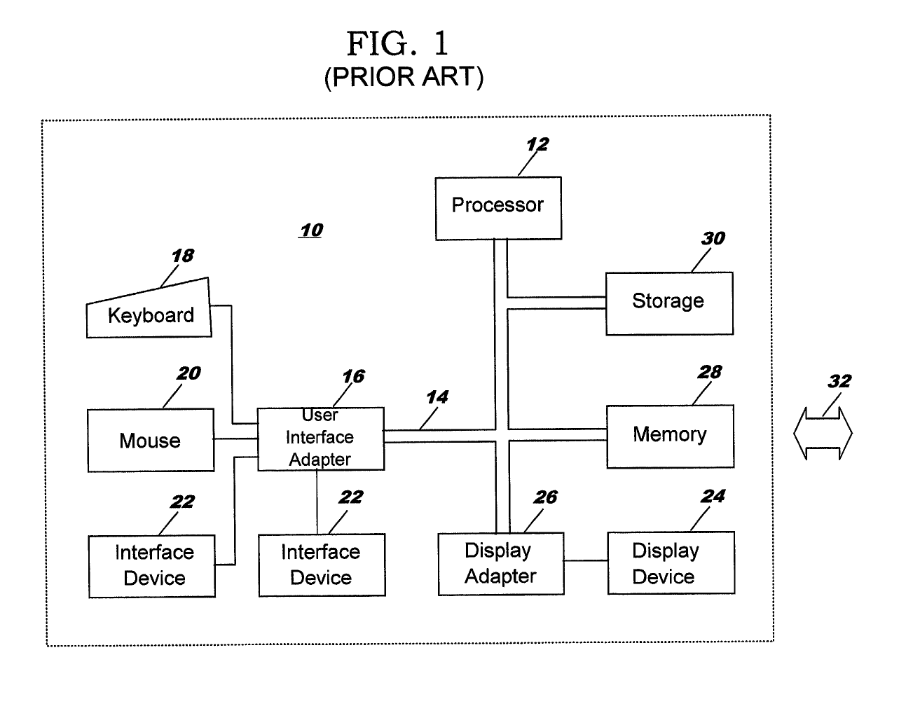

FIG. 1 illustrates a representative computer hardware environment in which the present invention may be practiced. FIG. 1 represents components of a computing device 10 which may be a personal digital assistant (“PDA”), handheld computer, Web-enabled cellular phone, etc. In preferred embodiments, this computing device is mobile, and thus the term “mobile computing device” will be used hereinafter. The mobile computing device 10 includes a microprocessor 12 and a bus 14 employed to connect and enable communication between the microprocessor 12 and the components of the mobile computing device 10 in accordance with known techniques. The mobile computing device 10 typically includes a user interface adapter 16, which connects the microprocessor 12 via the bus 14 to one or more interface devices, such as a keyboard 18, mouse 20, and/or other interface devices 22 such as a touch sensitive screen, digitized entry pad, etc. The bus 14 also connects a display device 24, such as a liquid crystal display (“LCD”) screen, to the microprocessor 12 via a display adapter 26. The bus 14 also connects the microprocessor 12 to memory 28 and long-term storage 30 which can include a hard drive, diskette drive, etc.

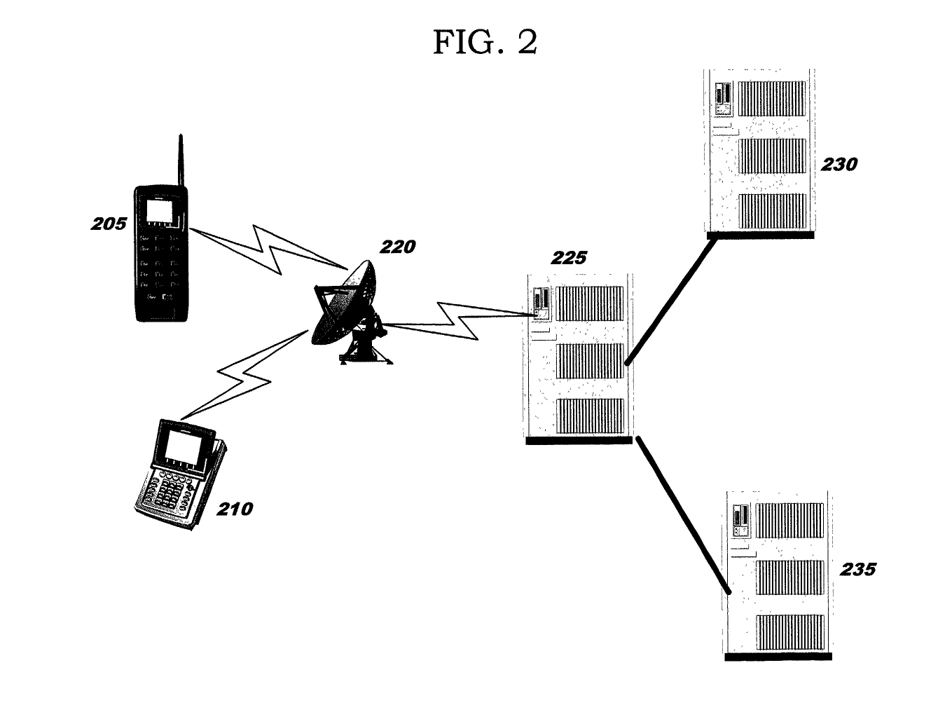

A mobile computing device using the techniques of the present invention preferably operates in a networking environment to communicate with other computers or networks of computers, for example via a modem or wireless interface at 32 (which, as one example, may be a cellular digital packet data, or “CDPD”, card). A simple example of such a network is represented in FIG. 2, wherein example mobile computing devices are shown as a Web-enabled cell phone 205 and PDA 210, connected using wireless network connections to a cellular tower 220 and then by land connections to a server 225 (which may be an edge server, proxy, firewall, or other networking device). Server 225 in this example configuration connects to one or more other server-side devices 230 and 235, which may be Web application servers, legacy host application or database servers, and so forth.

In preferred embodiments, the user's mobile computing device is connected using a wireless connection to a server, as shown in FIG. 2. Wireless connections use media such as satellite links, radio frequency waves, and infrared waves. Many connection techniques can be used with these various media, such as using a cellular modem to establish a wireless connection. The user's mobile computing device may be any type of processor, such as those described above, having processing and communication capabilities. The remote server, similarly, can be one of any number of different types of computer which have processing and communication capabilities. These techniques are well known in the art, and the hardware devices and software which enable their use are readily available.

While a wireless connection is used in preferred embodiments, alternatively a wireline connection may be used. Wireline connections are those that use physical media such as cables and telephone lines. As an example of use of a wireline connection, the shopping path may be computed initially while the user's mobile computing device is connected to a network using a wireline connection, and this computed shopping path may then be consulted as the user follows the path. (The user's mobile computing device may remain offline during the shopping process in this approach, or the user may connect the device during the shopping process by establishing a wireless connection or by re-establishing a wireline connection.) Note that the present invention may also be used advantageously with other network configurations and/or other types of client and server devices (examples of which will be described herein).

These configurations, as well as the communications hardware and software which enables their use, are known in the art. A detailed description thereof herein is not deemed necessary for a thorough understanding of the inventive concepts of the present invention.

Preferably, the present invention is implemented in software, although hardware or a combination of software and hardware may be used alternatively. For purposes of discussion, it will be assumed that the invention is implemented in software. Software programming code which embodies the present invention is typically located partly on the user's mobile computing device and partly on one or more servers or mainframes (hereinafter referred to as “servers” for ease of reference, and illustrated in FIG. 2 by servers 225, 230, and/or 235) and is accessed from long-term storage media of some type, such as a CD-ROM drive or hard drive. (For example, software on the user's device may perform functions such as displaying the shopping path, while software on a server typically performs functions such as determining inventory availability at a particular merchant.) The software programming code may be embodied on any of a variety of known media for use with a data processing system, such as a diskette, hard drive, or CD-ROM.

The code may be distributed on such media, or may be distributed from the memory or storage of one computer system over a network of some type to other computer systems for use by such other systems. Alternatively, the programming code may be embodied in the memory, and accessed by a processor using a system bus. The techniques and methods for embodying software programming code in memory, on physical media, and/or distributing software code via networks are well known and will not be further discussed herein.

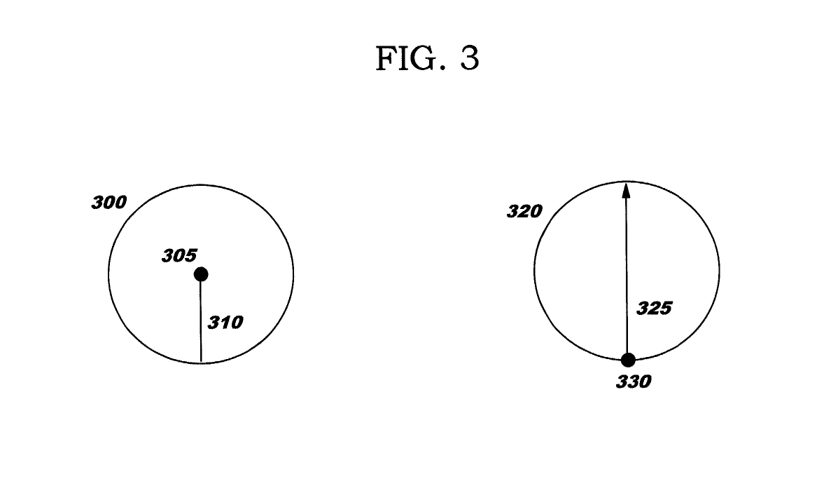

FIG. 3 illustrates two alternative approaches to determining a shopping area in which merchants may be selected. In a first approach, a starting point 305 and a radius 310 are provided, and a shopping area 300 is determined using this information. In a second approach, a starting location 330 and compass direction and distance 325 (illustrated in the example as pointing due north with a distance that represents a diameter) are provided, and a shopping area 320 is determined whereby the starting location 330 is located on the circle which extends therefrom, for the distance provided, in the direction 325 of the compass. (When distance is specified as a diameter, the user may perhaps have a better grasp of the sense of maximum straight-line distance to be traveled. Alternatively, the distance may be specified in other ways, such as using a radius value.) The starting point and radius or starting point, compass direction, and distance may be obtained by prompting the user to provide the information, by querying stored information (which may include a preferred geographic starting location such as the location of the user's home, or perhaps the user's work location if he prefers to begin his shopping trip after leaving work, etc.) from a user preferences file, or using other similar techniques. Optionally, the starting point and/or compass direction may be automatically obtained by determining the current location of the user's mobile computing device. A global positioning system (“GPS”) or other type of location process (such as a triangulation algorithm) may be used for this purpose, as is known in the art. Other approaches to determining a shopping area may be used without deviating from the inventive concepts disclosed herein, such as by providing its metes and bounds, street location boundaries, latitude and longitude boundaries, and so forth. (The shopping areas 300 and 320 are shown in FIG. 3 as being circular for purposes of illustration only.)

Furthermore, boundaries of the shopping area may be predefined in some cases. As an example, the present invention may be implemented as a shopping service within a shopping mall. In this case, the shopping boundary is preferably predefined as the shopping mall. Users may access such a service from kiosks placed throughout the mall, or perhaps from computers which are provided in various merchants' stores. An implementation of this type does not necessarily require the user to have a mobile computing device: instead, users may access the shopping service by (for example) arriving at a kiosk, swiping their credit card or other personal identifier through a reader at the kiosk, and then using the techniques of the present invention (as will be described below) to obtain a mall-based shopping list. As a further example, a predefined shopping area might be restricted to a group of merchants within the physical boundary of the shopping mall. This may be beneficial for merchants who choose to provide this shopping service to their customers (and who may also provide in-store computers or other devices for customers to access the functions of the present invention). Similar techniques may, of course, be used in scenarios other than shopping malls.

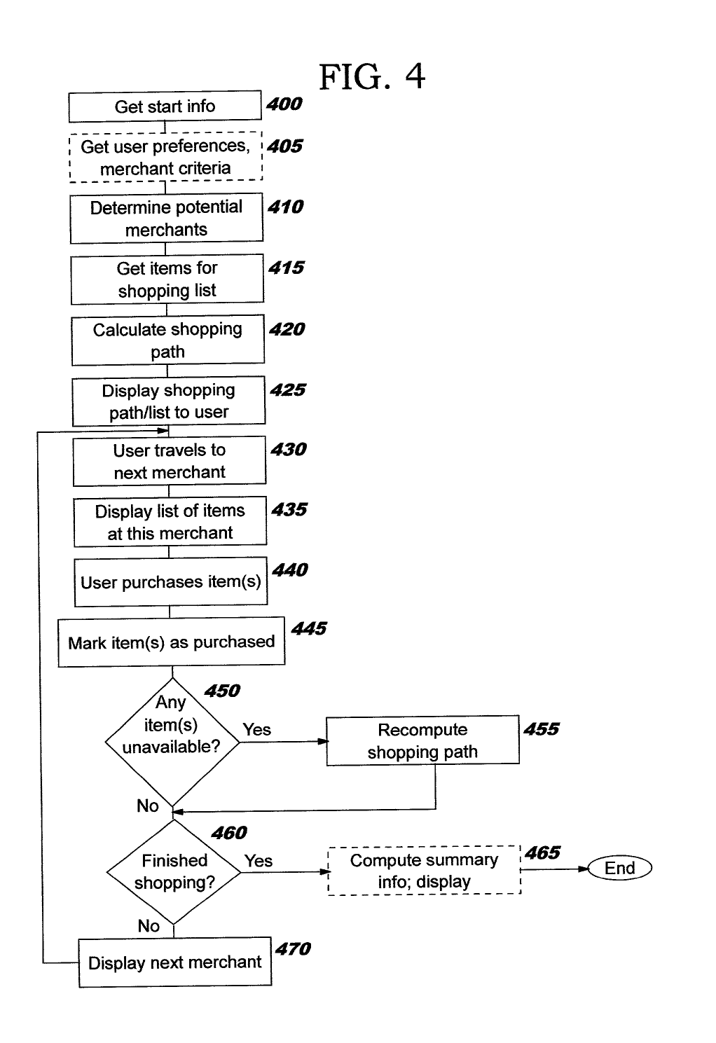

Preferred embodiments of logic which may be used to implement the present invention will now be discussed in more detail with reference to the flowchart in FIG. 4.

Initially, the starting location information is obtained (Block 400). Several alternative approaches for obtaining this information have been described above with reference to FIG. 3. At Block 405, information used to customize selection of a shopping path for the user according to various factors is obtained. (Block 405 is depicted using a dashed outline to indicate that this process is optional, in implementations which use default values and do not provide for customization.) The factors to be obtained may reflect the user's preferences, various merchant criteria, and so forth. For example, the user may choose to optimize her shopping path to obtain the lowest total price, the least number of stops, etc. Additional criteria that may be used in this process include:

1) Merchant lockout: The user may be allowed to specify particular merchants to be excluded from the shopping path.

2) Merchant preference: The user may be allowed to specify a preference for particular merchants.

3) Merchant acceptance criteria: Factors such as whether a particular merchant accepts certain credit cards, accepts personal checks, allows checks to be cashed, accepts coupons, provides double coupons, will match another merchant's advertised price, and so forth may be specified, and the user may be allowed to request preferential consideration for determining the shopping path using these factors.

4) Availability of items in merchant's internet warehouse: Whether a particular merchant can fulfill an item from its warehouse in case the item is out of stock in its brick-and-mortar store may be considered.

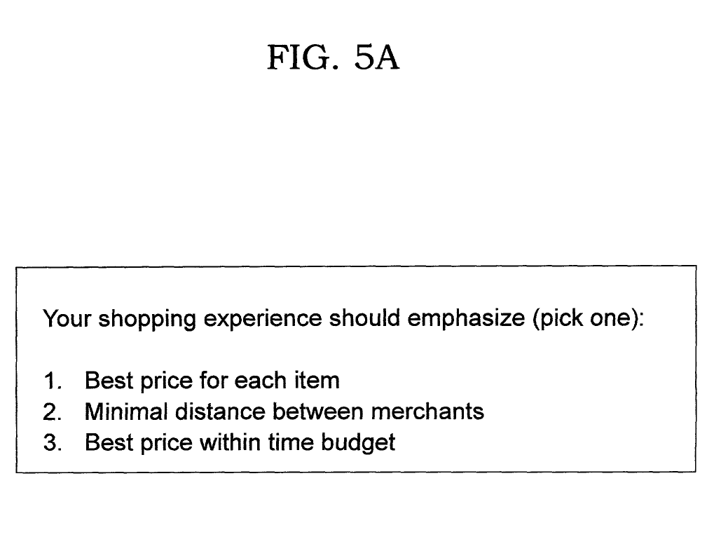

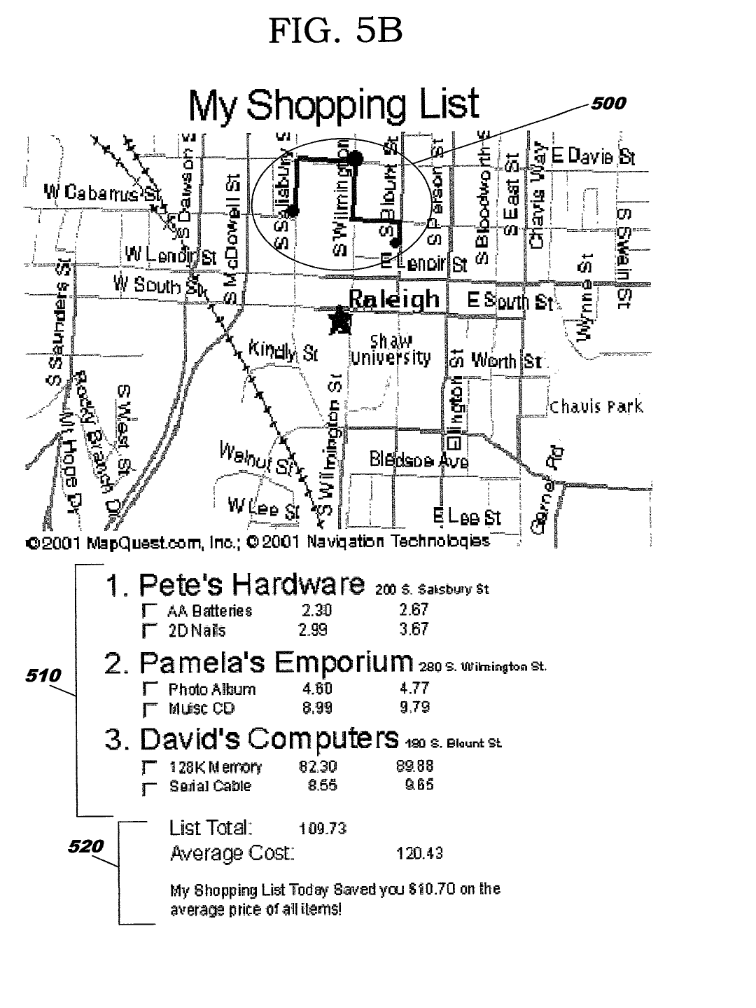

When customization options are provided, the user may be presented with choices such as those shown in FIG. 5A, wherein a selection may be made among factors which will be used when determining an optimal shopping path. As shown in this example, a user may select to optimize the path based upon price (option 1) or minimal distance (option 2). Or, the user may be asked to provide his “time budget” — that is, how much time he has available for shopping on this trip. A relatively larger amount of time may be taken as an indication that the user can shop longer, so that price should be given preference over distance, while a relatively shorter amount of time may be taken as an indication of the opposite situation.

In Block 410, a set of potential merchants is determined, where this set preferably comprises those merchants within the shopping area which have not been explicitly excluded. Techniques for determining merchants within a geographical area are known in the art. For example, MapSource™ software may be used with an “eMap” device from Garmin Corporation to determine the nearby restaurants or shopping locations within proximity of a geographic location. (“MapSource” is a trademark of MAPSource, Inc.) Optionally, the set of obtained merchants may be restricted according to the present invention to those merchants providing particular types of goods or services (such as only locating grocery stores or only locating hardware stores). Techniques such as Universal Description, Discovery, and Integration (“UDDI”), which is an on-line registry in which businesses worldwide may list themselves and information such as their products and/or services and their location, may be used in Block 410 to locate those merchants providing particular types of products.

The list of items that comprises the user's current shopping list is obtained (Block 415). Many different techniques or combinations thereof may be used for this process. For example, the user may be prompted to manually provide identifying information for products, such as a name, description, or UPC (“Universal Product Code”) or other code; a wand or scanner may be used to scan a UPC or other code from an already-purchased product or from a catalog, advertisement, coupon, or other literature; identifying information may be retrieved from an on-line source such as through the Internet; a previously-created list may be accessed; and so forth. (An on-line UPC service such as that provided at location http://www.rnrcomputing.com/upc/, which locates a product's UPC given its description and vice versa, or a barcode service such as that described at location http://www.debarcode.com/deBarcode/html/index.html, which locates a manufacturer's web site using an entered UPC, may be used if desired during the processing of Block 415.) During this process, if an item price is determined (for example, as an advertisement or coupon is being scanned), this price is preferably remembered (e.g. for use in computing the shopping path if price is to be used as a path optimizing criterion, for displaying to the user as illustrated in FIG. 5B, and/or for use in a pricing strategy of the type described below with reference to Block 465). Optionally, means may be provided for indicating those items on the shopping list which may be considered perishable, and this information is then also preferably remembered for use in computing the shopping path. (For example, it may be preferable to schedule purchases of all perishable items near the end of the shopping path.) Means for indicating perishable items include prompting the user, accessing previously-stored product information which includes a “perishable yes/no” flag, determining whether the product is in a category which has previously been identified as perishable (such as “ice cream”), and so forth.

The items identified for the user's shopping list may or may not be a homogeneous type of product. That is, the items might all be groceries or other similar products; different types of products or services; or a combination of products and services such as groceries, dry cleaning, and automotive parts.

Note that the order of blocks in FIG. 4 may be altered if desired. For example, it may be preferable in particular implementations to obtain the list of items on the shopping list (Block 415) before determining the set of potential merchants (Block 410) in order to constrain the set to those providing only the type of products needed for this shopping list.

An optimized shopping path is then computed (Block 420). Several different approaches may be used for this process. In a first approach, each merchant in the set of potential merchants is contacted electronically to determine which items on the user's shopping list are in stock at this merchant. This information may then be used as input to algorithms which provide solutions to the well-known “traveling salesman problem” (as will be described in more detail below) in order to compute an overall shopping path from the starting location identified in Block 400. Preferably, the price of each available item from the shopping list is remembered when the merchant is contacted (e.g. if price is to be considered when computing the shopping path, for displaying to the user as illustrated in FIG. 5B, and/or for use in a pricing strategy of the type described below with reference to Block 465). In a second approach, the nearest merchant in the set of potential merchants may be determined, and this nearest merchant is then contacted electronically to determine which products from the shopping list are available; the remainder of the shopping path may then be determined iteratively using a revised shopping list which comprises only those products which were not available at a prior merchant location on the path.

In addition to the factors discussed above with reference to Block 405, determination of the optimized path may consider whether the user is walking or driving, what traffic will be encountered if driving, and so forth. Optionally, one or more alternative paths may be provided (for example, in cases where the route selection criteria does not provide a differentiation among merchants which exceeds some threshold, such as: total overall cost is within $5.00 of a preferred path; overall route is within 1 mile of a preferred path; number of stops is identical to a preferred path), and the user may be allowed to choose a path from among those provided. Software for determining the shopping path may reside on the user's computing device in some embodiments, or may reside at a service provider which is accessible from the user's computing device in other embodiments. Furthermore, in embodiments such as the shopping mall scenario previously described, software for determining the shopping path may reside in locations accessible from the kiosk or similar portal which is accessible to user without a specially-adapted computing device.

Algorithms for determining an optimized path between two locations using techniques of graph theory are known in the art, and implementations thereof may be readily constructed by one ordinary skill. More than one algorithm may be applied, if desired, to obtain a better approximation. The selection of algorithm may be determined by the available processing power, criticality of obtaining a better approximation, etc. Conceptually, a cost is associated with traveling from one location to another. In a simple implementation, this cost is measured as the distance between points. In one approach, straight-line distance or driving distance may be used and may be determined by querying an electronic location service (for example, using the eMap device previously described). This approach is preferable when the user chooses to optimize the shopping path by overall path length. In a more complex implementation, cost might be computed using an algorithm that considers distance and/or other factors such as travel time or product cost.

A relatively good approximation for solving the traveling salesman problem may be obtained using the “nearest neighbor” algorithm. The set of costs for this algorithm may be recorded conceptually using a matrix that represents the merchant locations on both axes, where an intersection in the matrix represents the cost of traveling between the locations represented by the corresponding row and column. From a giving starting point, the nearest neighbor algorithm selects the smallest cost from the set of costs in the row (when proceeding row-wise) or column (when proceeding column-wise) for that starting location. Once selected, that intersection is no longer available, and the next location represented by the selected column (when proceeding row-wise) or row (when proceeding column-wise) is used to iteratively repeat the process until a complete path to a destination has been determined.

A user may choose to have a shopping path that is computed according to the present invention always return the user to the starting location. Or, the user may be allowed to identify a different ending location. For example, the user may select her office as the starting location and her home as the ending location. In some implementations, the user may also be allowed to specify a preferred last location prior to reaching the end of the computed path. For example, the user may wish to visit a grocery store just prior to returning home (where his home location represents the end of the path) so that purchased perishable items will not spoil, or he may wish to visit his parents' home or other location prior to returning home.

When computing the nearest neighbor algorithm, if a final or fixed destination of the type just described has been set, then the intersection cell representing the cost (i.e. path) from that destination back to the starting location is pre-selected, and no longer available for selection or omission by the algorithm. If a new path is computed during a shopping trip, such as when a user is optionally allowed to add or change items during the shopping trip or when an item was not available for purchase where originally expected (as will be discussed in more detail below, with reference to Blocks 450 and 455), then the cell representing the cost (path) from the current merchant location to the final location (which may be the starting location or an alternate ending location specified by the user) is pre-selected, and no longer available for selection or omission by the algorithm. The remaining merchants in the potential merchant set may change (unless fixed by the user) when a new path is calculated. In these cases, all other parameters of the calculation remain the same.

The path resulting from execution of the traveling salesman algorithm approximation then represents an optimal shopping path. A given implementation may subsequently apply another algorithm, as stated above, if better results are desired. For example, the well-known “2-opt exchange” algorithm may be applied after the nearest neighbor algorithm to determine a better path or to provide the user with multiple paths from which to select.

If the user has chosen to provide a shopping time budget, as discussed above with reference to option 3 of FIG. 5A, then multiple iterations of the shopping path determination may be used to obtain better path selections for the user. For example, a first iteration may select a path based upon price, but if the time required to follow this shopping path exceeds the time budget, then one or more additional iterations may be performed to select alternative paths based upon distance (or a combination of price and distance).

When factors other than path length and price are used as criteria to optimize the shopping path, as described above with reference to Block 405, these factors may be used to influence selection of the optimized path in a similar manner (e.g. by using these factors when computing the entries in the cells for the nearest neighbor algorithm).

Once an optimized path has been computed, it is preferably displayed or otherwise provided (e.g. by printing a map, by displaying driving directions, etc.) to the user (Block 425). If more than one path has been computed, the user preferably selects from among these paths; the selected path is referred to hereinafter as the “computed” path. At some point, the user then the shopping process by traveling to the first merchant on the computed path (Block 430). Upon subsequent iterations of this logic, Block 430 represents traveling to the next merchant on the shopping path, rather than traveling to the first merchant.

Preferably, the list of available products from the current merchant is displayed or otherwise provided (for example, by printing a list or by speaking the list using a speech generation component of the mobile computing device) to the user (Block 435). The user may then purchase one or more items (Block 440) from this current merchant. Preferably, the items which are purchased are marked on the shopping list as being completed (Block 445). In one embodiment, the user may manually record purchases of particular items, or may cause the purchase to be recorded by scanning information such as a UPC from the items. In another embodiment, the merchant's checkout register may record an identification of purchased items and may transmit this record (for example, using wireless transmission protocols) to the user's computing device (or perhaps to a server where the shopping list is stored) for use in updating the user's shopping list. Software that remembers a revised shopping list which reflects information such as completed purchases may be present on the user's mobile computing device in some embodiments, or may reside at a service provider which is accessed from the user's computing device in other embodiments.

In an embodiment where a shopping path which indicates those products which are expected to be available at a particular merchant is determined prior to reaching the merchant, Block 450 checks to see if any expected items were not available. If this test has a positive result, then control transfers to Block 455 where the shopping path is recomputed to account for those items. In this recomputing, preference may be given to those merchants which are on (or near) the uncompleted segment of the previously-computed path. When the test in Block 450 has a negative result, processing continues at Block 460.

In an alternative embodiment where each segment of the shopping path is computed based upon the items which remain on the shopping list after shopping at a particular merchant, with no expectations of purchasing particular products from particular merchants, the test in Block 450 is preferably replaced by a test having semantics of “Any products remaining to be purchased?”.

Block 460 checks to see if the shopping process is complete. This test has a positive result when all items from the shopping list have been acquired and also when items exist for which no suitable merchant can be found (such as when the item is out of stock at all potential merchants). Control then transfers to Block 465, which represents an optional summary process whereby information regarding the shopping process may be computed and presented to the user. After performing this summary processing, the process of FIG. 4 then ends. Example information that may be generated in Block 465 includes the total cost of the products purchased, how much money the user saved as compared to list prices on this shopping trip, which items were not available from any merchant, which items were not available from merchants that represented the items as being available, the total distance covered, and/or the total number of merchants visited. Optionally, this information may be used as input to a pricing strategy whereby, for example, the user pays a percentage of her savings or perhaps a percentage of the cost of the items on the completed shopping list to a shopping service provider. For example, a percentage may be provided to the kiosk owner in the shopping mall scenario. As another alternative, participating merchants such as those located within the mall might contribute a portion of their revenues which result from use of the present invention to the kiosk service provider.

When the test in Block 460 has a negative result, processing continues at Block 470 where the next merchant on the shopping path is displayed or otherwise indicated to the user. Control then returns to Block 430 to perform the acquisition of products from this merchant.

Optionally, the user may be allowed to modify the shopping list during the shopping process, although this has not been depicted in FIG. 4. It will be obvious to one of ordinary skill in the art how the logic of FIG. 4 may be modified to provide this option. Upon receiving a revised list of products from the user, the shopping path is recomputed using the current location as a starting point, and the shopping process then continues. This type of modification may occur, for example, because the user has found an item (or similar item which is an acceptable substitute) at a merchant earlier in the shopping path than where the computed list anticipated purchasing that item.

FIG. 5B illustrates a sample user interface that may be provided to indicate the selected shopping path to the user. As shown in this example, the user has requested to purchase some hardware items, a photo album and music CD, and some computer equipment. A path (shown within encircled element 500) is illustrated on a city map. An identification of each selected merchant, along with a list of items to be purchased from that merchant, as shown at element 510. A checkbox may be provided for indicating when each purchase has been completed. The expected sales price and normal retail price for each item may also be displayed, as shown in the example. A total for the items may be provided, along with a total of the normal retail price and a summary of the cost savings, as shown at 520.

As has been demonstrated, the present invention provides advantageous techniques for computing an optimized shopping path. The path and/or shopping list may be dynamically revised (or dynamically computed) as purchases are completed. The benefits of the present invention may be realized for virtually any type of shopping application. (Note that while preferred embodiments of the present invention have been described with reference to purchasing products, the inventive techniques disclosed herein are equally applicable to purchasing services or a combination of products and services.) Software which embodies the present invention may be installed on a mobile computing device which may in some cases be marketed as a shopping path locator device.

As will be appreciated by one of skill in the art, embodiments of the present invention may be provided as methods, systems, or computer program products and may be used to provide novel methods of doing business. As stated earlier, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of optimizing a shopping list process, comprising steps of:
obtaining a shopping list comprising one or more items;
obtaining one or more factors which a user wishes to use in optimizing a shopping path for the items on the shopping list;
determining one or more merchants and locations thereof where the items may be purchased; and
computing the shopping path to visit selected ones of the merchants, wherein the merchants are selected according to the one or more obtained factors.

2. The method according to claim 1, wherein one of the obtained factors is to optimize a path length for the shopping path.

3. The method according to claim 1, wherein one of the obtained factors is to optimize a purchase cost for the items on the shopping list.

4. The method according to claim 1, wherein one of the obtained factors is to optimize a number of merchants on the shopping path.

5. The method according to claim 1, further comprising steps of:
traveling to each successive merchant on the computed shopping path;
purchasing zero or more items from the shopping list at each merchant; and
remembering which items have been purchased.

6. The method according to claim 5, further comprising steps of:
creating a revised shopping list which excludes the remembered items; and
determining whether items expected at a particular one of the merchants were available for purchase, and if not, recomputing the shopping path after adding the items which were unavailable to the revised shopping list.

7. The method according to claim 1, wherein the shopping path begins from an identified starting location and terminates at an identified ending location, which may be identical to the starting location.

8. The method according to claim 1, wherein one or more traveling salesman algorithm implementations are used by the computing step.

9. The method according to claim 1, wherein the merchants are dynamically contacted to determine availability of the items on the shopping list.

10. The method according to claim 5, further comprising the step of computing a summary after visiting the selected merchants, wherein the summary comprises information pertaining to one or more of which merchants were visited; the remembered items which were purchased; a cost of the remembered items which were purchased; a count of merchants visited; a cost savings of the remembered items which were purchased.

11. A system for optimizing a shopping list process, comprising steps of:
means for identifying one or more items on a shopping list;
means for identifying one or more factors which a user wishes to use in optimizing a shopping path for the identified items;
means for determining one or more merchants and locations thereof where the identified items may be purchased; and
means for computing the shopping path to visit selected ones of the merchants, wherein the merchants are selected according to the one or more identified factors.

12. The system according to claim 11, further comprising means for remembering which items from the shopping list have been purchased while traveling to each successive merchant on the computed shopping path.

13. The system according to claim 12, further comprising:
means for creating a revised shopping list which excludes the remembered items; and
means for determining whether items expected at a particular one of the merchants were available for purchase, and if not, recomputing the shopping path after adding the items which were unavailable to the revised shopping list.

14. A computer program product for optimizing a shopping list process, the computer program product embodied on one or more computer-usable media and comprising:
computer readable program code means for identifying one or more items on a shopping list;
computer readable program code means for identifying one or more factors which a user wishes to use in optimizing a shopping path for the identified items;
computer readable program code means for determining one or more merchants and locations thereof where the identified items may be purchased; and
computer readable program code means for computing the shopping path to visit selected ones of the merchants, wherein the merchants are selected according to the one or more identified factors.

15. The computer program product according to claim 14, further comprising computer readable program code means for remembering which items from the shopping list have been purchased while traveling to each successive merchant on the computed shopping path.

16. The computer program product according to claim 15, further comprising:
computer readable program code means for creating a revised shopping list which excludes the remembered items; and
computer readable program code means for determining whether items expected at a particular one of the merchants were available for purchase, and if not, recomputing the shopping path after adding the items which were unavailable to the revised shopping list.
